(19) United States
(12) Patent Application Publication
(10) Pub. No.: US 2016/0156829 A1
(43) Pub. Date: Jun. 2, 2016

(54) IMAGE CAPTURING SYSTEM AND CAPTURED-IMAGE DATA PUBLISHING SYSTEM

(71) Applicant: PFU LIMITED, Ishikawa (JP)

(72) Inventors: Masaya TAKAMORI, Ishikawa (JP); Yuki KASAHARA, Ishikawa (JP); Yuki MATSUDA, Ishikawa (JP)

(21) Appl. No.: 14/656,452

(22) Filed: Mar. 12, 2015

(30) Foreign Application Priority Data
Nov. 28, 2014 (JP) 2014-242122

(51) Int. Cl. H04N 5/232; H04N 1/00; H04N 5/225

(52) U.S. Cl. CPC H04N 5/23203; H04N 5/23296; H04N 5/2253; H04N 1/00244; H04N 1/00209

(57) ABSTRACT

An image capturing system to capture an image of an object from various directions. The system includes a mobile terminal and an image-capturing assist device. The mobile terminal includes an image capturing unit, and a terminal-equipment controller to control the mobile terminal. The image-capturing assist device includes a turntable including a placing table to place the object thereon, a housing rotatably supporting the placing table, an actuator to rotate the placing table, and a turntable-equipment controller to control the turntable, and a mobile-terminal placing table to place the mobile terminal such that the image capturing unit and the object on the placing table face each other. The mobile terminal and the image-capturing assist device perform communication therebetween, and the terminal-equipment controller controls the actuator when starting image capturing to intermittently or continuously photograph the object on the placing table, sequentially when the placing table is rotating.

### CROSS-REFERENCE TO RELATED APPLICATION(S)

The present application claims priority to and incorporates by reference the entire contents of Japanese Patent Application No. 2014-242122 filed in Japan on Nov. 28, 2014.

### BACKGROUND OF THE INVENTION

1. Field of the Invention

The present disclosure relates to an image capturing system and a captured-image data publishing system.

2. Description of the Related Art

Conventionally, image capturing systems that capture an image of or photograph an object to be captured, i.e. an object to be photographed, hereinafter object to photo, on a turntable from various directions have been reported (for example, such as Japanese Patent Application Laid-Open No. 2013-225733, Japanese Patent Application Laid-Open No. 10-23297, Japanese Utility Model No. 3098827).

However, in the conventional technologies (such as Japanese Patent Application Laid-open No. 2013-225733, Japanese Patent Application Laid-open No. 10-23297, Japanese Utility Model No. 3098827), there is room for improvement in efficiency when photographing an photographed object on a turntable from various directions.

### SUMMARY OF THE INVENTION

It is an object of the present invention to at least partially solve the problems in the conventional technology.

According to an aspect of the present invention, an image capturing system to capture an image of an object to be photographed from various directions comprises a mobile terminal and an image-capturing assist device. The mobile terminal includes an image capturing unit; and a terminal-equipment controller configured to control the mobile terminal. The image-capturing assist device includes a turntable including an object-to-photo placing table on which the object to be photographed is placed, a housing rotatably supporting the object-to-photo placing table around a rotating shaft, an actuator configured to rotate the object-to-photo placing table around the rotating shaft, and a turntable-equipment controller configured to control the turntable; and a mobile-terminal placing table held to face the housing, and configured to place the mobile terminal in a state where the image capturing unit and the object to be photographed placed on the object-to-photo placing table face each other. The mobile terminal and the image-capturing assist device perform communication therebetween, and the terminal-equipment controller controls the actuator through the turntable-equipment controller, at a time when starting image capturing by the image capturing unit, and intermittently or continuously captures an image of the object to be photographed placed on the object-to-photo placing table, in a sequential manner, in a state of rotating the object-to-photo placing table around the rotating shaft.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a hardware configuration diagram of an image capturing system according to an embodiment;

FIG. 2 is a function block diagram of a captured-image data publishing system including the image capturing system illustrated in FIG. 1;

FIG. 3 is a diagram illustrating an integrated state of an image-capturing assist device according to an embodiment;

FIG. 4 is a diagram illustrating a disassembled state of an image-capturing assist device according to an embodiment;

FIG. 5 is a diagram illustrating an accommodated state of an image-capturing assist device according to an embodiment;

FIG. 6 is a diagram illustrating an example of a photographing field of a mobile terminal according to an embodiment;

FIG. 7 is a diagram illustrating another example of a photographing field of a mobile terminal according to an embodiment;

FIG. 8 is a diagram illustrating an expanded state of a background unit according to an embodiment;

FIG. 9 is a diagram illustrating an accommodated state of a background unit according to an embodiment;

FIG. 10 is a diagram illustrating an example of an installation position of a light source unit according to an embodiment;

FIG. 11 is a diagram illustrating an example of an accommodating structure of a relative-position changing unit according to an embodiment;

FIG. 12 is a diagram illustrating another example of an accommodating structure of a relative-position changing unit according to an embodiment;

FIG. 13 is a diagram illustrating an example of a mounted position of an image capturing unit of a mobile terminal according to an embodiment;

FIG. 14 is a diagram illustrating an example of a dimension of a mobile-terminal placing table according to an embodiment;

FIG. 15 is a diagram illustrating a state in which a mobile terminal is placed on a mobile-terminal placing table according to an embodiment;

FIG. 16 is a diagram illustrating an example of a mobile-terminal placing table according to an embodiment;

FIG. 17 is a diagram illustrating another example of a mobile-terminal placing table according to an embodiment;

FIG. 18 is a diagram illustrating another example of a mobile-terminal placing table according to an embodiment;

FIG. 19 is a diagram illustrating another example of a mobile-terminal placing table according to an embodiment;

FIG. 20 is a diagram illustrating another example of a mobile-terminal placing table according to an embodiment;

FIG. 21 is a flowchart illustrating an outline of processing of an image capturing system and a captured-image data publishing system according to an embodiment;

FIG. 22 is a flowchart illustrating details of processing of an image capturing system according to an embodiment;

FIG. 23 is a flowchart illustrating details of processing of an image capturing system according to an embodiment;

FIG. 24 is a flowchart illustrating details of capturing condition setting processing according to an embodiment;

FIG. 25 is a flowchart illustrating details of photographed-object centering processing according to an embodiment;

FIG. 26 is a diagram illustrating a state of an object to photo rotated on an object-to-photo placing table according to an embodiment, and of an object to photo, which is captured as n-th photographed image data;

FIG. 27 is a diagram illustrating an object to photo rotated on the object-to-photo placing table according to an embodiment, and of an object to photo, which is captured as (n+1)-th photographed image data;

FIG. 28 is a diagram for describing centered-object cropping processing included in photographed-object centering processing according to an embodiment;

FIG. 29 is a diagram for describing magnification correction processing included in photographed-object centering processing according to an embodiment; and

FIG. 30 is a flowchart illustrating details of background deletion processing according to an embodiment.

### DETAILED DESCRIPTION OF THE PREFERRED EMBODIMENTS

Hereinafter, embodiments of an image capturing system and a captured-image data publishing system according to the present invention will be described with reference to the drawings. Note that the present invention is not limited by the embodiments described below. Further, configuration elements in the embodiments include matters that can be easily assumed by a person skilled in the art and are substantially the same. Note that, in the drawings below, the same portion or a corresponding portion is denoted with the same reference sign, and repetitive description is omitted.

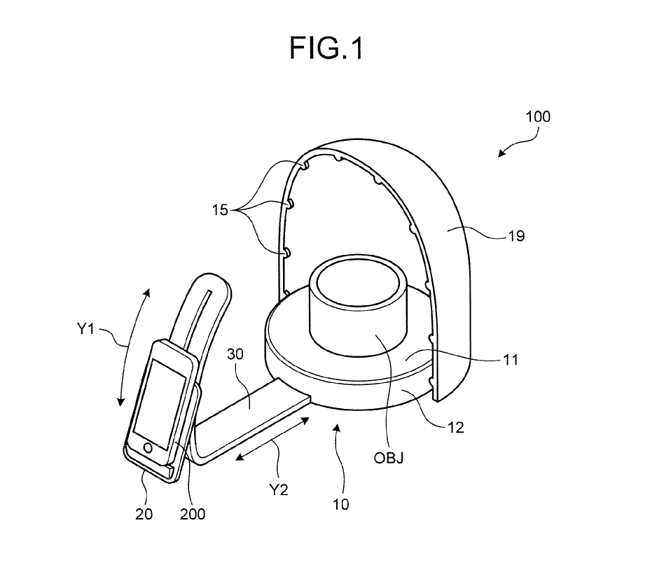

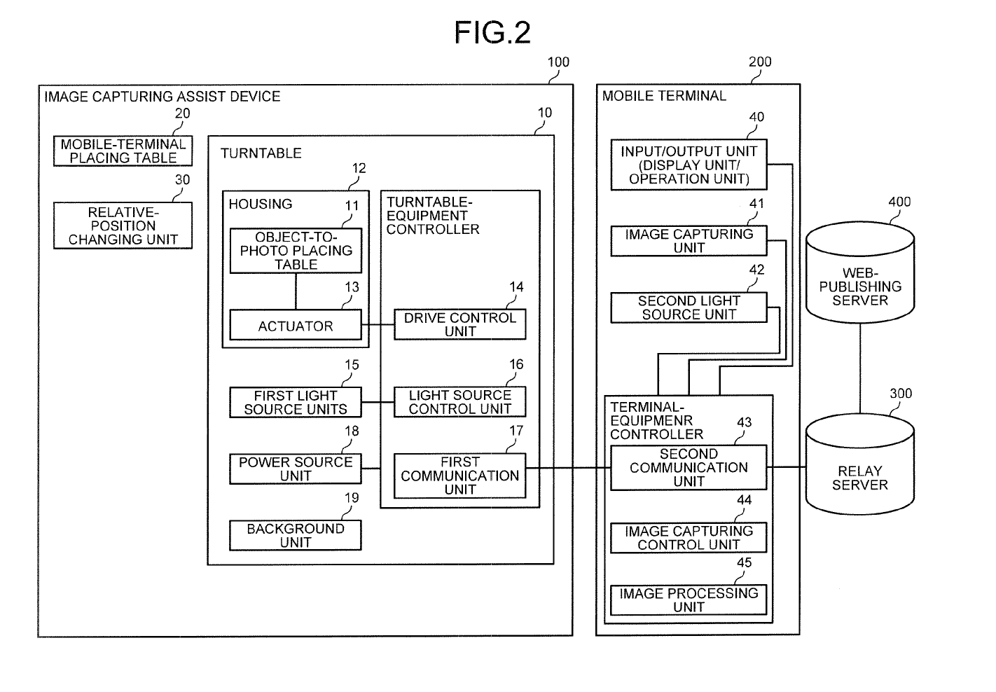

Configurations of an image capturing system and a captured-image data publishing system will be described with reference to FIGS. 1 and 2. FIG. 1 is a hardware configuration diagram of an image capturing system according to an embodiment. FIG. 2 is a functional block diagram of the captured-image data publishing system including the image capturing system illustrated in FIG. 1.

As illustrated in FIGS. 1 and 2, the image capturing system according to the present embodiment includes an image-capturing assist device 100 and a mobile terminal 200. In the image capturing system of the present embodiment, the image-capturing assist device 100 includes a turntable 10 on which an object to photo OBJ is placed, and the image-capturing assist device 100 and the mobile terminal 200 are connected so that mutual communication is possible. In the image capturing system of the present embodiment, control, of rotation of the turntable 10 of the image-capturing assist device 100 is performed at the mobile terminal 200, and an image capturing unit 41 of the mobile terminal 200 continuously or intermittently captures an image of or photographs the object to photo OBJ which rotates on an object-to-photo placing table 11 of the image-capturing assist device 100.

Further, the captured-image data publishing system according to the present embodiment includes the image capturing system including the image-capturing assist device 100 and the mobile terminal 200, a relay server 300, and a web-publishing server 400. In the captured-image data publishing system of the present embodiment, the relay server 300 performs communication with the mobile terminal 200, and automatically uploads captured image data, i.e. photographed image data, which the mobile terminal 200 generates photographing the object to photo OBJ, to the predetermined web-publishing server 400. At this time, the mobile terminal 200 and/or the relay server 300 photographs the image of the object to photo OBJ and processes the photographed image data generated, according to a condition requested by the web-publishing server 400.

Hereinafter, details of compositions of the image-capturing assist device 100 and the mobile terminal 200 that compose the image capturing system will be described in order. Following that, details of compositions of the relay server 300 and the web-publishing server 400 will be described.

The image-capturing assist device 100 is a device that assists photographing of the object to photo OBJ, and generally includes the turntable 10, a mobile-terminal placing table 20, and a relative-position changing unit 30.

The turntable 10 schematically includes the object-to-photo placing table 11, a housing 12, an actuator 13, a drive control unit 14, one or more first light source units 15, a light source control unit 16, a first communication unit 17, a power supply unit 18, and a background unit 19.

In the turntable 10 of the image-capturing assist device 100, the object-to-photo placing table 11 is a disk-shaped placing table, and the object to photo OBJ is placed on an upper surface of the object-to-photo placing table 11. The housing 12 is a cylindrically shaped housing with an upper surface open. An upper end portion of a rotating shaft extending upward from a central portion of the housing 12 is connected to a central portion of a lower surface of the object-to-photo placing table 11. These central portions are positioned in the center of the turntable 10. Accordingly, the housing 12 is composed to rotatably support the object-to-photo placing table 11 around the rotating shaft. Further, a bottom portion may be separately provided to the housing 12, and the rotating shaft may be extended upward from a central portion of the bottom portion. Alternatively, the rotating shaft may be supported by an attaching member, and extended upward from the center of the turntable 10. Accordingly, a space to accommodate the relative-position changing unit 30, which will be described later, can be secured in the housing 12.

The actuator 13, which functions as a drive unit that rotates the object-to-photo placing table 11 around the rotating shaft, is provided in the housing 12, and the actuator 13 is controlled by the drive control unit 14 that functions as a part of a control unit equipped at the turntable, hereinafter turntable-equipment controller. The actuator 13 is, for example, a motor that rotates the rotating shaft, and is designed such that a rotating direction and/or a rotating speed can be adjusted by the drive control unit 14.

The first light source units 15 are lighting devices that irradiate the object to photo OBJ placed on the object-to-photo placing table 11 with light. The first light source units 15 can switch ON or OFF of the irradiation, by being controlled by the light source control unit 16 that functions as a part of the turntable-equipment controller. Further, the light source control unit 16 can adjust irradiation amounts or irradiation ranges of the illumination lights, according to an illumination condition. The first light source units 15 are installed at respective protruding portions provided at a plurality of places of an end portion of the half-dome shaped background unit 19, and are installed to irradiate the object to photo OBJ placed on the object-to-photo placing table 11 with light. Note that the background unit 19 may just have a structure that upwardly protrudes from the object-to-photo placing table 11, and surrounds a part of the object-to-photo placing table 11, and is not limited to the half-dome shape. Further, in the present embodiment, the background unit 19 is installed to be positioned within an image capturing region of the image capturing unit 41 of the mobile terminal 200, in a state where the mobile terminal 200 is placed on the mobile-terminal placing table 20.

The first communication unit 17 performs data communication with the mobile terminal 200. In the present embodiment, the first communication unit 17 functions as a part of the turntable-equipment controller. The first communication unit 17 receives various control signals transmitted from the mobile terminal 200, for example. The drive control unit 14 and/or the light source control unit 16 of the turntable-equipment controller controls the actuator 13 and/or the first light source unit 15, based on the various control signals received by the first communication unit 17. The power supply unit 18 is a power source that supplies the power to the turntable-equipment controller. The power supply unit 18 is a battery, for example, and may be composed to be charged by an external power source.

As described above, in the present embodiment, the turntable-equipment controller (including the drive control unit 14, the light source control unit 16, and the first communication unit 17) has a function to control the actuator 13 and the first light source unit 15 of the turntable 10. Here, the turntable-equipment controller is a computer that includes a central processing unit (CPU), a random access memory (RAM), a read only memory (ROM), and the like. The CPU functions as a controller that executes various types of processing, and the RAM and the ROM function as memories that store various types of information. All or a part of the functions of the turntable-equipment controller is realized by performing reading/writing of data from/to the RAM or the ROM, by loading an application program held in the ROM to the RAM and executing the application program by the CPU. In the present embodiment, a command that provides the rotating direction and the rotating speed of the turntable 10, a command that provides the illumination condition of the first light source unit 15, and the like are stored in the memories of the turntable-equipment controller.

The mobile-terminal placing table 20 is a placing table on which the mobile terminal 200 can be placed. The mobile-terminal placing table 20 is a rectangular flat plate structure which has a holder and an installation surface that are provided on a front surface of the flat plate structure and hold the mobile terminal 200. In the present embodiment, the mobile-terminal placing table 20 is composed to be able to place the mobile terminal 200, in a state where the image capturing unit 41 of the mobile terminal 200 faces the object to photo OBJ placed on the object-to-photo placing table 11. A first hinge portion 30′ that can change an angle of the mobile-terminal placing table 20 in an upward or downward direction, i.e. vertical direction, is provided on a back surface of the mobile-terminal placing table 20, and the mobile-terminal placing table 20 is connected with the relative-position changing unit 30 through the first hinge portion 30′.

The relative-position changing unit 30 is a V-shaped structure made of rectangular flat plate which is bent approximately in a V shape, and functions as an arm that integrates the mobile-terminal placing table 20 and the turntable 10. In the relative-position changing unit 30, the mobile-terminal placing table 20 is arranged on a front surface of the flat plate on one side of the V-shaped structure with respect to a bent portion of the V shape, hereinafter one-side flat plate, via the first hinge portion 30′. An end portion of the flat plate on other side of the V-shaped structure with respect to the bent position of the V shape, hereinafter other-side flat plate, is held by the housing 12.

A linear opening portion is provided in the one-side flat plate of the relative-position changing unit 30, in the vertical direction. With the linear opening portion, the first hinge portion 30′ of the mobile-terminal placing table 20 can move slidably in the vertical direction (in a direction of an arrow Y1 illustrated in FIG. 1). A fixing member such as a screw is equipped to the first hinge portion 30′ of the mobile-terminal placing table 20. After the mobile-terminal placing table 20 is slid in the vertical direction to a slide-target position, the fixing member can hold the mobile-terminal placing table 20 at the slide-target position.

The other-side flat plate of the relative-position changing unit 30 is composed to pass through an opening portion provided in a peripheral surface of the housing 12 of the turntable 10, and can slide in a direction toward a central portion of the housing 12 or in an opposite direction, that is, in a horizontal direction (in a direction of an arrow Y2 illustrated in FIG. 1). A fixing member such as a stopper is provided in the housing 12. After the other-side flat plate is slid in the horizontal direction to a slide-target position, the fixing member can hold the relative-position changing unit 30 at the slide-target position.

As described above, in the present embodiment, the relative-position changing unit 30 is designed to hold the mobile-terminal placing table 20 to face the housing 12, and to be able to change a relative position of the mobile-terminal placing table 20 with respect to the object-to-photo placing table 11. That is, the relative-position changing unit 30 has a function to change the relative position of the mobile-terminal placing table 20 with respect to the object-to-photo placing table 11, by being slid in the horizontal direction with respect to the object-to-photo placing table 11, and/or by sliding the mobile-terminal placing table 20 in the vertical direction.

The mobile terminal 200 schematically includes an input/output unit 40, the image capturing unit 41, a second light source unit 42, a second communication unit 43 as a control unit equipped at the mobile terminal, hereinafter terminal-equipment controller, an image capturing control unit 44, and an image processing unit 45. In the present embodiment, the mobile terminal 200 is a mobile-type information processing terminal device such as a smartphone.

The input/output unit 40 of the mobile terminal 200 is a touch panel having a function as a display unit and an operation unit, and is installed on the front surface of the mobile terminal 200. Various control signals input through the input/output unit 40 are output to the terminal-equipment controller. Examples of the control signals input through the input/output unit 40 includes, but are not limited to, a command that starts the image capturing of the object to photo OBJ by the image capturing unit 41, a command that starts the rotation of the turntable 10 at the same time as the start of the image capturing, a command that processes the photographed image data generated after the capturing of the image, and a command that transmits the photographed image data after the image processing to the relay server 300. The terminal-equipment controller executes various types of processing, based on the various control signals input from the input/output unit 40.

The image capturing unit 41 is a camera built in the mobile terminal 200, and is installed in the back surface of the mobile terminal 200. The image capturing unit 41 captures the image of the object to photo OBJ, based on the control signals input from the terminal-equipment controller, to generate the photographed image data (moving image and/or still image data). The photographed image data generated in the image capturing unit 41 is output to the terminal-equipment controller. The terminal-equipment controller performs the image processing and the like with respect to the photographed image data generated in the image capturing unit 41, and transmits the processed data to the relay server 300.

The second light source unit 42 is a lighting device that is built in the mobile terminal 200 and emits light. The second light source unit 42 is installed in the back surface of the mobile terminal 200. The second light source unit 42 switches ON and OFF of the irradiation, according to the control signal input from the terminal-equipment controller.

The second communication unit 43 performs data communication with the image-capturing assist device 100 and the relay server 300. In the present embodiment, the second communication unit 43 functions as a Part of the terminal-equipment controller. The second communication unit 43 transmits, to the image-capturing assist device 100, the various control signals including the command that rotates the turntable 10, receives, from the relay server 300, data such as files and tables that indicate various conditions to be referred when capturing an image or performing the image processing, and transmits, to the relay server 300, the photographed image data after the image processing.

The image capturing control unit 44 controls the image capturing unit 41. In the present embodiment, the image capturing control unit 44 functions as a part of the terminal-equipment controller. The image capturing control unit 44 controls the image capturing unit 41, based on conditions that specify start timing of the image capturing, stop timing of the image capturing, and switching timing of an image capturing mode (a moving image mode or a still image mode), by the image capturing unit 41. Further, the image capturing control unit 44 sets capturing conditions so as to photograph the object to photo OBJ, according to conditions required by the web-publishing server 400 that is an upload destination of the photographed image data, and conditions stored in the relay server 300 in advance (for example, the number of images, the capacity, and the image size), and then executes image capturing by the image capturing unit 41. In addition, the image capturing control unit 44 transmits a control signal, which controls the rotation of the turntable 10, to the image-capturing assist device 100 through the second communication unit 43, at timing when executing control to the image capturing unit 41. The control signal includes the command that provides the rotating direction and the rotating speed of the turntable 10, and the like. Further, the image capturing control unit 44 transmits a control signal, which controls the first light source unit 15, to the image-capturing assist device 100 through the second communication unit 43, at timing when executing control to the image capturing unit 41. The control signal includes the command that provides the illumination condition of the first light source unit 15, and the like. In addition, the image capturing control unit 44 may display, in the input/output unit 40, the photographed image data generated after the image capturing, a condition changing screen so that the capturing condition can be adjusted, and the like.

As described above, the terminal-equipment controller controls the actuator 13 through the turntable-equipment controller at a time to start the image capturing by the image capturing unit 41, and captures an image of the object to photo OBJ placed on the object-to-photo placing table 11, continuously or intermittently in a sequential manner, in a state of rotating the object-to-photo placing table 11 around the rotating shaft. In the present embodiment, “intermittently” means a state in which the images, which are not a continuous moving image, but are intermittent images that are approximately continuous in a temporal and spatial manner, and with which the object to photo OBJ can be thoroughly expressed or grasped over approximately 360°, can be captured.

The image processing unit 45 executes the image processing with respect to the photographed image data. In the present embodiment, the image processing unit 45 functions as a part of the terminal-equipment controller. The image processing unit 45 executes the image processing of adjusting the position and a magnification of the object to photo OBJ in a plurality of photographed image data, for example. Note that details of the image processing by the image processing unit 45 will be described below. In addition, the image processing unit 45 may display, in the input/output unit 40, the photographed image data after the image processing, the condition changing screen so that conditions related to the image processing can be adjusted, and the like.

As described above, in the present embodiment, the terminal-equipment controller (including the second communication unit 43, the image capturing control unit 44, and the image processing unit 45) has the function to control not only the input/output unit 40, the image capturing unit 41, and the second light source unit 42, but also the turntable 10, the actuator 13, and the first light source unit 15 of the image-capturing assist device 100 side, through the turntable-equipment controller. Here, similarly to the turntable-equipment controller, the terminal-equipment controller is a computer including a CPU, a RAM, a ROM, and the like. The CPU functions as a controller that executes various types of processing. The RAM and the RCM function as memories that store various types of information. All or a part of the functions of the terminal-equipment controller is realized by performing reading/writing of data from/to the RAM or the ROM, by loading an application program held in the ROM to the RAM and executing the application program by the CPU. In the present embodiment, the data such as files and tables that are received from the relay server 300 and indicate the various conditions to be referred when capturing an image or performing the image processing, the photographed image data generated after the image capturing by the image capturing unit 41, the photographed image data after the image processing, and the like are stored in the memories in the terminal-equipment controller.

The relay server 300 is an image processing device having a function to perform communication with the mobile terminal 200 and the web-publishing server 400, and execute various types of processing. Although not illustrated, the relay server 300 has a typical server configuration that includes at least a control unit that is a CPU, a storage unit that is a RAM, a ROM, and the like, and a communication unit. The CPU functions as a controller that executes the various types of processing. The RAM and the ROM function as memories that store various types of information. The communication unit performs data communication of various control signals and various types of information. All or a part of the functions of the relay server 300 is realized by performing reading/writing of data from/to the RAM or the ROM, by loading an application program held in the ROM to the RAM and executing the application program by the CPU.

The communication unit of the relay server 300 receives the conditions required by the web-publishing server 400, and transmits the various conditions and the like, in response to the request from the mobile terminal 200. Further, the control unit of the relay server 300 executes the image processing with respect to the photographed image data transmitted from the mobile terminal 200. Here, the control unit of the relay server 300 executes the image processing of deleting a background portion other than the object to photo OBJ included in the photographed image data, and the like. Note that details of the image processing by the relay server 300 will be described below. Further, the communication unit of the relay server 300 executes processing of uploading the photographed image data after the image processing to the web-publishing server 400.

The storage unit of the relay server 300 stores the conditions required by the web-publishing server 400 (for example, conditions that provide the number of images, the capacity, the image size, and the like, according to a cooperative service (for example, an image publishing service of an electronic commerce site or the like) offered by the web-publishing server 400), as a definition object, stores the photographed image data received from the mobile terminal 200, and stores the photographed image data after the image processing.

The web-publishing server 400 is an information processing device having a function to perform communication with the relay server 300 and other external devices (for example, an information terminal device of a user who uses the cooperative service of the web-publishing server 400), and executes various types of processing. Although not illustrated, the web-publishing server 400 has a typical server configuration that includes at least a control unit that is a CPU, a storage unit that is a RAM, a ROM, and the like, and a communication unit, similarly to the above-described relay server 300. The CPU is a controller that executes the various types of processing. The RAM and the ROM function as memories that store various types of information. The communication unit performs data communication of various control signals and various types of information. All or a part of the functions of the web-publishing server 400 is realized by performing reading/writing of data from/to the RAM or the ROM, by loading an application program held in the ROM to the RAM and executing the application program by the CPU.

The communication unit of the web-publishing server 400 transmits various conditions and the like, which are necessary when uploading an image to the cooperative service (for example, the image publishing service of the EC site or the like) offered by the web-publishing server 400, in response to a request of the relay server 300. Further, the control unit of the web-publishing server 400 executes various types of processing so that the photographed image data transmitted from the relay server 300 can be published on the cooperative service. Accordingly, the photographed image data of the object to photo OBJ on the turntable 10 of the image-capturing assist device 100, the image having been captured by the mobile terminal 200, can be browsed by the information terminal device of the user who uses the cooperative service of the web-publishing server 400, through a network.

The storage unit of the web-publishing server 400 stores the conditions that provide the number of images, the capacity, the image size, and the like, according to the cooperative service provided by the web-publishing server 400, and stores the photographed image data received from the relay server 300.

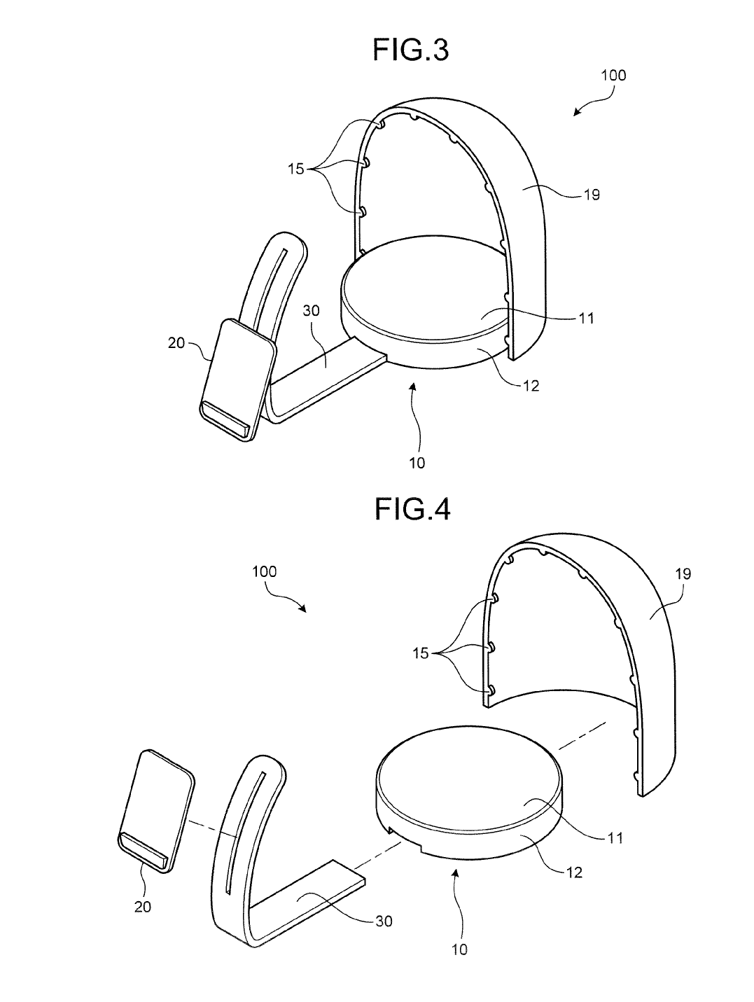

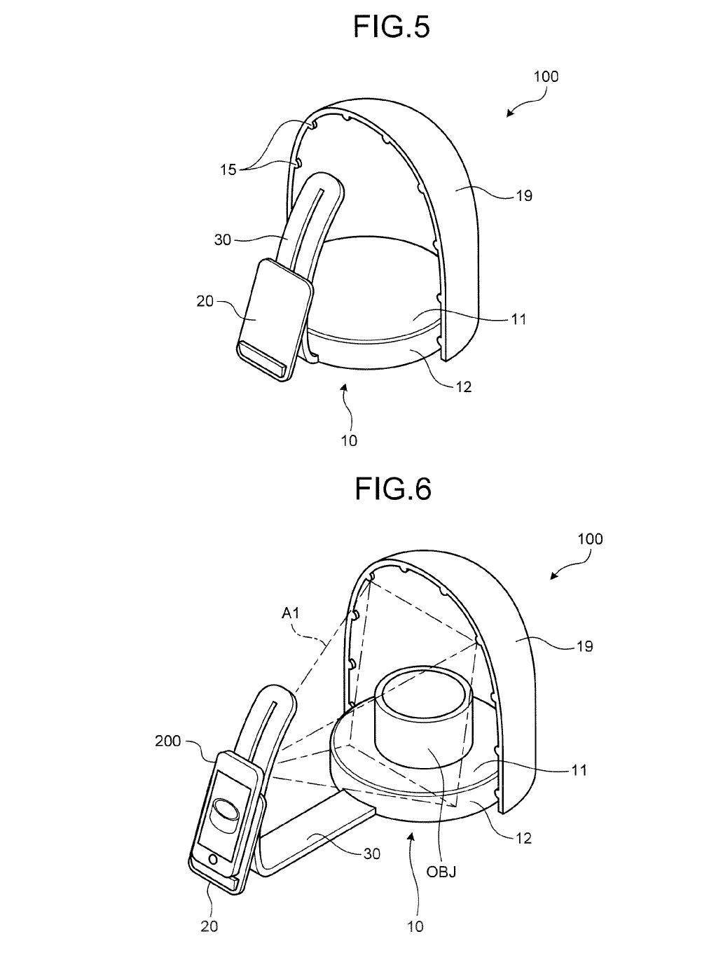

An example of an integrated state, a disassembled state, and an accommodated state of the image-capturing assist device 100 according to an embodiment will be described with reference to FIGS. 3 to 5. FIG. 3 is a diagram illustrating an integrated state of an image-capturing assist device according to an embodiment. FIG. 4 is a diagram illustrating a disassembled state of the image-capturing assist device according to an embodiment. FIG. 5 is a diagram illustrating an accommodated state of the image-capturing assist device according to an embodiment.

An image capturing system illustrated in FIG. 3 includes, similarly to FIG. 1, the image-capturing assist device 100 and the mobile terminal 200. Note that the image-capturing assist device 100 illustrated in FIG. 3 is similar to the one in the image capturing system illustrated in FIG. 1, except that the object to photo OBJ is not placed on the object-to-photo placing table 11 of the turntable 10, and thus description of members is omitted. As illustrated in FIG. 3, the mobile-terminal placing table 20 on which the mobile terminal 200 is placed and the turntable 10 are connected through the relative-position changing unit 30, so that the image-capturing assist device 100 is in the integrated state.

FIG. 4 illustrates a state in which the members of the image-capturing assist device 100 illustrated in FIG. 3 are disassembled. As illustrated in FIG. 4, among the members of the turntable 10, the background unit 19 including the first light source unit 15, is composed to be detachable from the housing 12 including the object-to-photo placing table 11, by an operation of the user. The relative-position changing unit 30 is also composed to be detachable from the housing 12 including the object-to-photo placing table 11, by an operation of the user. Further, the first hinge portion 30′, arranged on the back surface of the mobile-terminal placing table 20, is composed to be attachable to or detachable from the opening portion in the front surface of the flat plate on the one side of the V-shaped structure of the relative-position changing unit 30, so that the mobile-terminal placing table 20 can be detachable by an operation of the user.

FIG. 5 illustrates a state in which the other-side flat plate of the relative-position changing unit 30 of the image-capturing assist device 100 illustrated in FIG. 3 is accommodated in the housing 12 of the turntable 10, by being slid in the horizontal direction toward an approximately center of the turntable 10, by the operation of the user. As described above, the image-capturing assist device 100 according to the present embodiment is composed such that the background unit 19, the housing 12, the mobile-terminal placing table 20, and the relative-position changing unit 30 can be disassembled by the operation of the user, and a part of the relative-position changing unit 30 can be accommodated in the housing 12. Accordingly, the user can accommodate the image-capturing assist device 100 in a compact manner, when the user does not use the image-capturing assist device 100.

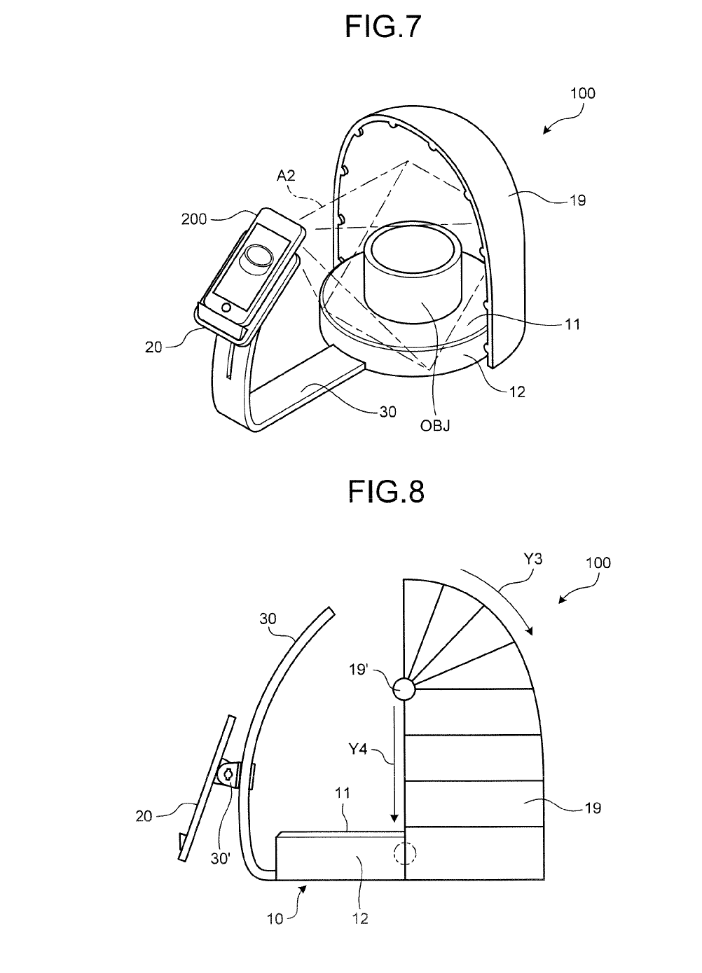

A photographing field of the image capturing unit 41 mounted on the mobile terminal 200 according to an embodiment will be described with reference to FIGS. 6 and 7. FIG. 6 is a diagram illustrating an example of the photographing field of the mobile terminal according to the embodiment. FIG. 7 is a diagram illustrating another example of the photographing field of the mobile terminal according to the embodiment.

As illustrated in FIGS. 6 and 7, the photographing field of the image capturing unit 41 is adjustable by the user's operation of sliding the mobile-terminal placing table 20, on which the mobile terminal 200 is placed, in the vertical direction on the relative-position changing unit 30. The example of FIG. 6 shows the photographing field A1 in a state where the mobile-terminal placing table 20 is positioned at a lower side of the flat plate on the one side of the V-shaped structure of the relative-position changing unit 30. The example of FIG. 7 shows a photographing field A2 in a state where the mobile-terminal placing table 20 is positioned at an upper side of the flat plate on the one side of the V-shaped structure of the relative-position changing unit 30. In the present embodiment, positional relationship among the turntable 10, the mobile-terminal placing table 20, and the relative-position changing unit 30, of the image-capturing assist device 100, is designed such that, when the user places the mobile terminal 200 on the mobile-terminal placing table 20, the photographing field of the image capturing unit 41 (for example, the photographing field A1, the photographing field A2, and the like) falls within the background unit 19. Further, the photographing field of the image capturing unit 41 can be adjusted, by changing an angle of the first hinge portion 30′ provided on the back surface of the mobile-terminal placing table 20. Accordingly, the user can photograph the object to photo OBJ on the turntable 10 from various directions with various angles over 360°.

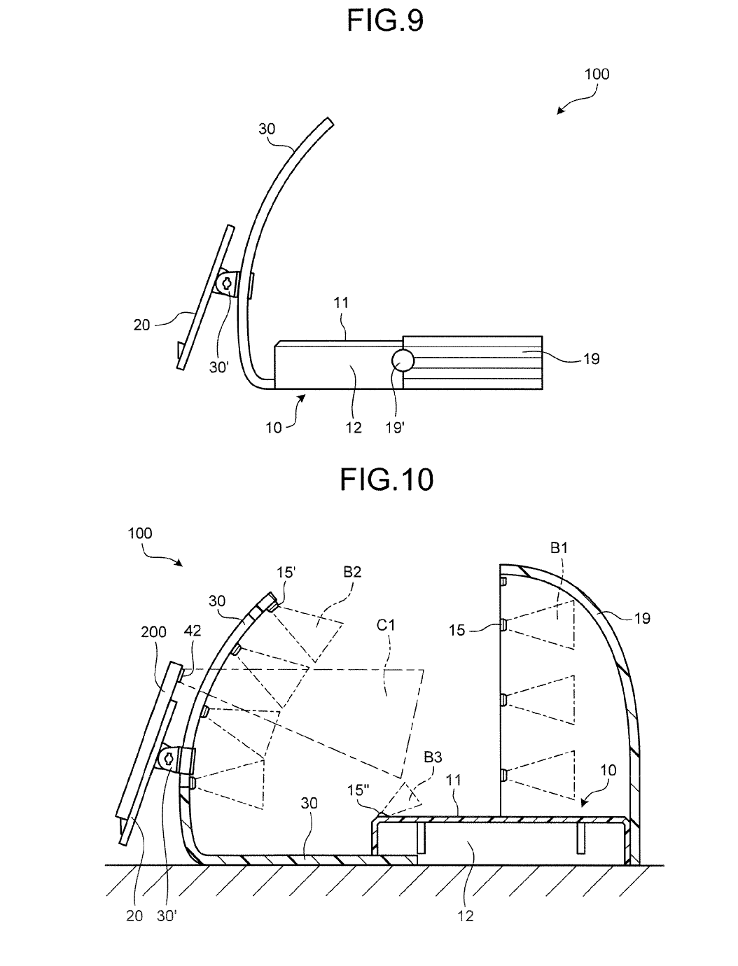

An example of an accommodating structure of the background unit 19 of the image-capturing assist device 100 according to an embodiment will be described with reference to FIGS. 8 and 9. FIG. 8 is a diagram illustrating an expanded state of the background unit according to the embodiment. FIG. 9 is a diagram illustrating an accommodated state of the background unit according to the embodiment.

In FIGS. 1, and 3 to 7, a half-dome shaped structure that covers half of the object-to-photo placing table 11 has been described as the background unit 19. However, as illustrated in FIGS. 8 and 9, the background unit 19 according to the present embodiment may have a half-dome shaped bellows structure that can be accommodated by a contracting operation of the user. FIG. 8 illustrates a state in which the background unit 19 having the bellows structure is expanded. As illustrated in FIG. 8, the background unit 19 having the half-dome shaped bellows structure is designed such that one side of the member folded by the contracting operation of the user accords with the height of the housing 12 including the object-to-photo placing table 11. A part of an upper portion of the background unit 19 can be folded in a direction of an arrow Y3 around a second hinge portion 19′ as a rotating shaft, by an operation of the user, and the second hinge portion 19′ is moved in a direction of an arrow Y4 and is further folded, so that the background unit 19 having the half-dome shaped bellows structure is contracted to be accommodated. FIG. 9 illustrates a state in which the background unit 19 having the half-dome shaped bellows structure is folded by the contracting operation of the user, and is accommodated in the periphery of the housing 12 including the object-to-photo placing table 11. As described above, the background unit 19 according to the present embodiment may be configured to be switchable between the expanded state of surrounding a part of the object-to-photo placing table 11 (the state illustrated in FIG. 8), and the accommodated state of being accommodated in the periphery of the object-to-photo placing table 11 (the state illustrated in FIG. 9). Note that the side views of FIGS. 8 and 9 illustrate a state in which the first hinge portion 30′ arranged in the back surface of the mobile-terminal placing table 20, which is not illustrated in the perspective views of FIGS. 1, 3 to 7, is connected with the relative-position changing unit 30.

An installation example of the first light source unit 15 of the image-capturing assist device 100 and the second light source unit 42 of the mobile terminal 200 according to the embodiment will be described with reference to FIG. 10. FIG. 10 is a diagram illustrating an example of an installation position of the light source units according to the embodiment.

FIG. 10 illustrates a cross section of the image capturing system according to the present embodiment as viewed from a side in a state where the image capturing system is divided along the center of the turntable 10 symmetrically. As illustrated in FIG. 10, the first light source units 15 of the image-capturing assist device 100 may be installed not only at the protruding portions provided at a plurality of places of the end portion of the background unit 19, but also on the relative-position changing unit 30 and the housing 12. In FIG. 10, the background unit 19 is irradiated with the illumination lights emitted by the first light source units 15 installed at the protruding portions (an irradiation range B1). The object-to-photo placing table 11 on which the object to photo OBJ is placed is irradiated with illumination light emitted by light source units 15′ installed at a plurality of places in the back surface of the flat plate on the one side of the V-shaped structure of the relative-position changing unit 30 (an irradiation range B2). The object-to-photo placing table 11 on which the object to photo OBJ is placed is irradiated with illumination light emitted by light source units 15″ installed at an appropriate position at an outside of the housing 12 (an irradiation range B3). Note that the light source units 15″ installed at the housing 12 is fixed to a position where the light source unit 15″ are not moved with the rotation of the object-to-photo placing table 11, with an appropriate attaching member or the like. In addition, in FIG. 10, the second light source unit 42 provided in the back surface of the mobile terminal 200 placed on the mobile-terminal placing table 20 irradiates the object-to-photo placing table 11 with illumination light (an irradiation range C1). The second light source unit 42 of the mobile terminal 200 is installed in the vicinity of the image capturing unit 41 provided in the back surface of the mobile terminal 200.

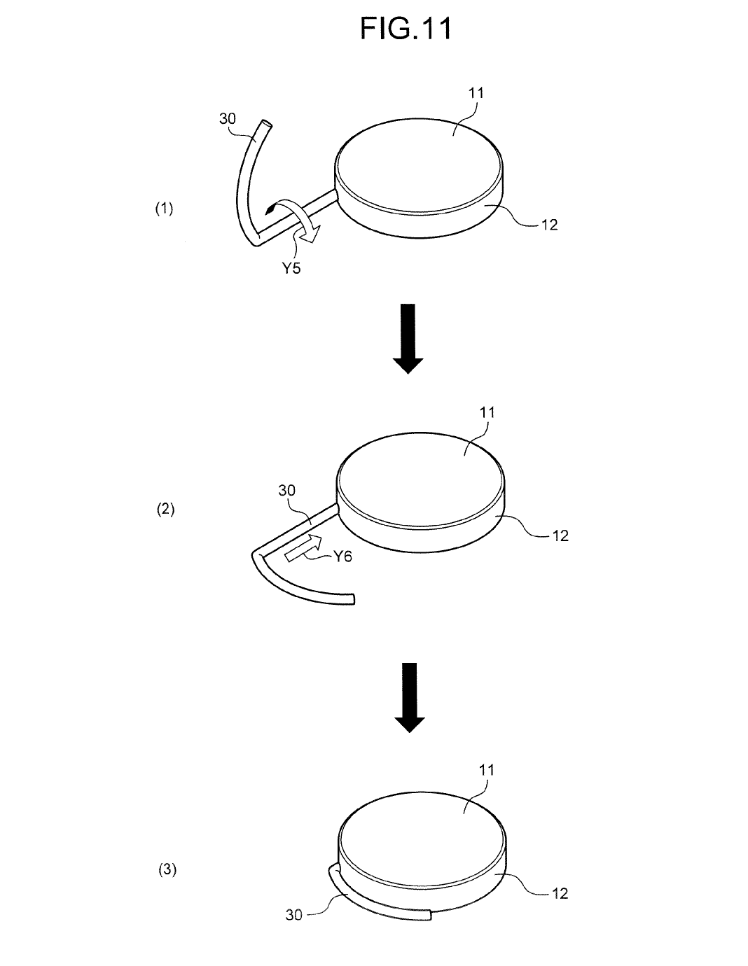

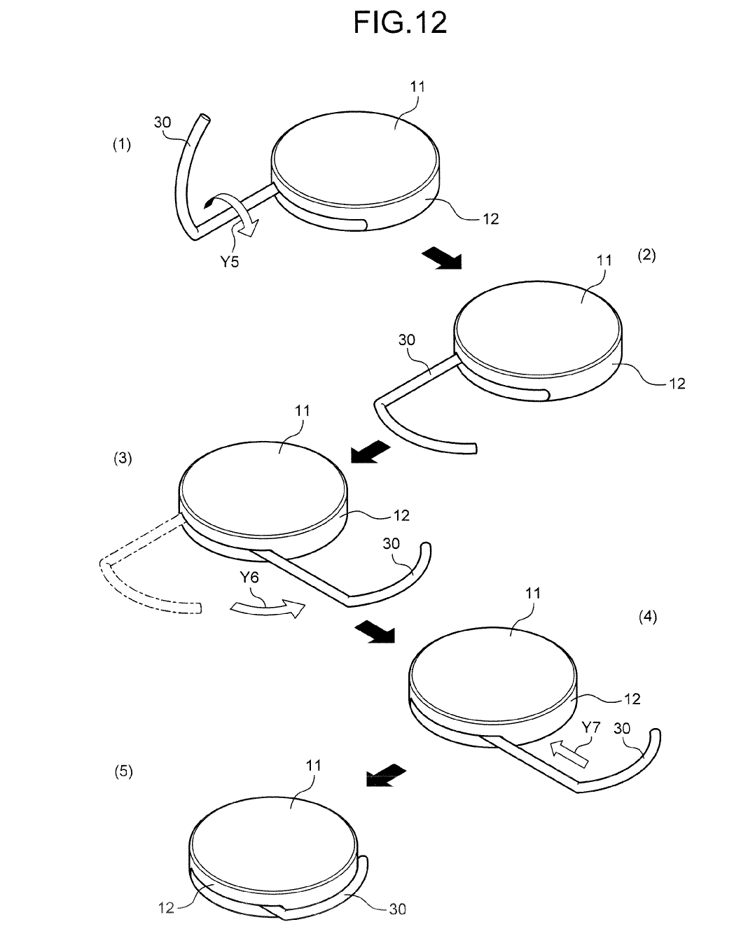

An accommodating example of the relative-position changing unit 30 of the image-capturing assist device 100 according to the embodiment will be described with reference to FIGS. 11 and 12. FIG. 11 is a diagram illustrating an example of an accommodating structure of the relative-position changing unit according to the embodiment. FIG. 12 is a diagram illustrating another example of the accommodating structure of the relative-position changing unit according to the embodiment.

In FIGS. 1, and 3 to 10 illustrate the rectangular flat plate structure bent approximately in the V shape, as the example of the relative-position changing unit 30. However, as illustrated in FIGS. 11 and 12, the relative-position changing unit 30 according to the present embodiment may have a bar structure bent approximately in a V shape at a bent portion. As illustrated in FIG. 11, the relative-position changing unit 30 having the bar structure is composed to be rotatable and accommodated in a state where the mobile-terminal placing table 20 is removed. In FIG. 11, the relative-position changing unit 30 is composed such that the relative-position changing unit 30 has bar portions on a one side and an other side with respect to the bent portion, and the bar portion on the one side with respect to the bent position, of the relative-position changing unit 30, corresponding to the portion where the mobile-terminal placing table 20 is attached, is rotatable in a direction of an arrow Y5 in a clockwise manner, by an operation of the user. Further, the bar portion on the other side with respect to the bent position, of the relative-position changing unit 30, is horizontally slid in a direction of an arrow Y6 toward an inside of the housing 12, by an operation of the user, so that the relative-position changing unit 30 can be accommodated in the periphery of the housing 12.

In addition, as illustrated in FIG. 12, the relative-position changing unit 30 may have a structure that, after the bar portion on the one side with respect to the bent position, of the relative-position changing unit 30, is rotated in the direction of the arrow Y5 in the clockwise manner, by an operation of the user, the bar portion on the one side with respect to the bent position is horizontally slidable in the direction of the arrow Y6 along an opening portion provided along the peripheral surface of the housing 12. Note that, although not illustrated, the bar portion on the other side with respect to the bent position of the relative-position changing unit 30 has a structure of being folded inside the housing 12, at the time of being slid, with a hinge portion or the like provided in advance at an appropriate position. Accordingly, after the bar portion on the other side with respect to the bent position of the relative-position changing unit 30 is horizontally slid in the direction of the arrow Y6, by the operation of the user, a accommodated position of the relative-position changing unit 30 is in a shifted position from the center of the turntable 10. Then, in this state, the bar portion on the other side with respect to the bent position of the relative-position changing unit 30 is horizontally slid in a direction of an arrow Y7 toward the inside of the housing 12, by the operation of the user, so that the relative-position changing unit 30 can be accommodated in the periphery of the housing 12.

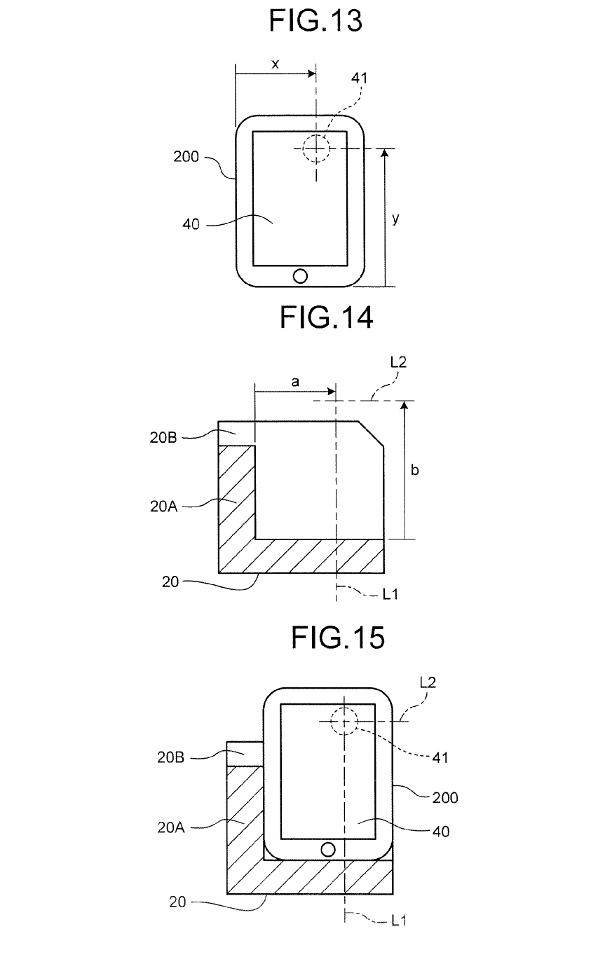

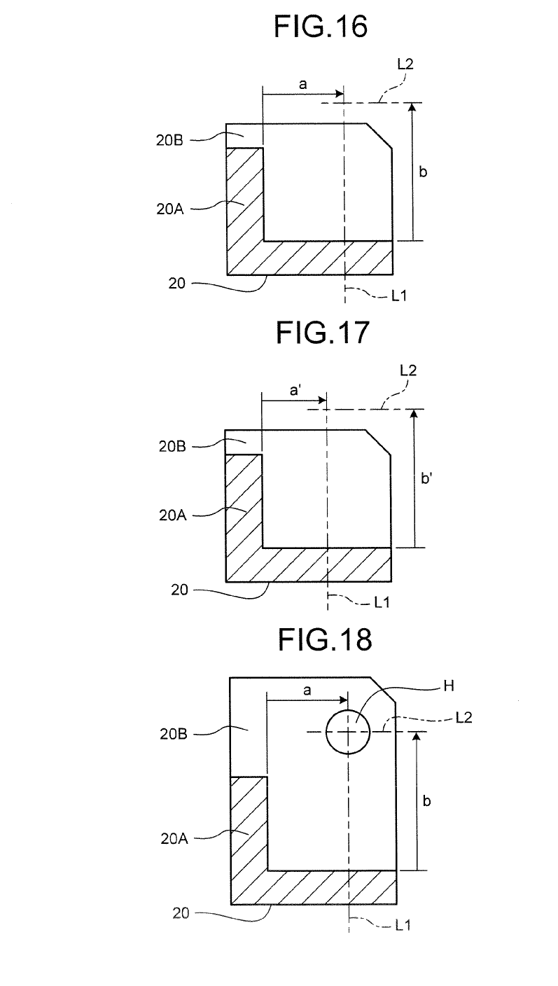

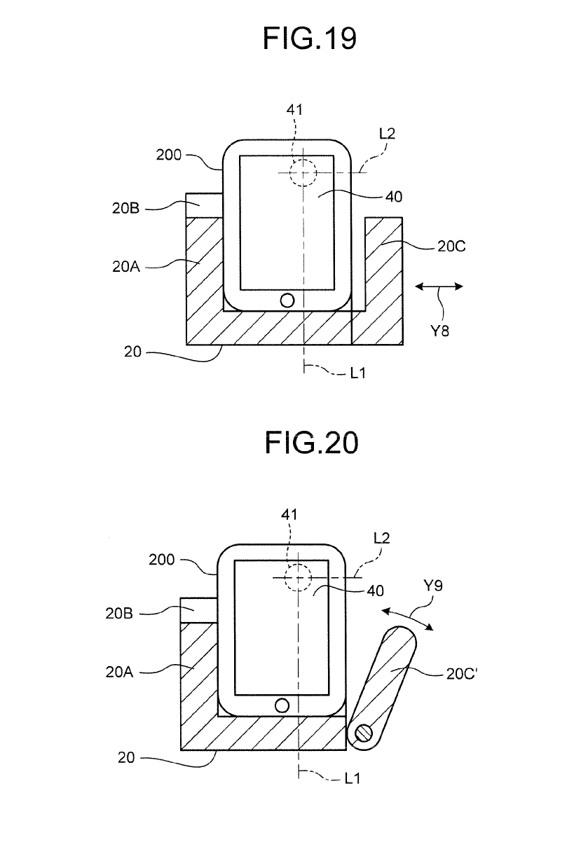

Details of the mobile-terminal placing table 20 according to the embodiment will be described with reference to FIGS. 13 to 20. FIG. 13 is a diagram illustrating an example of a mounted position of an image capturing unit of the mobile terminal according to the embodiment. FIG. 14 is a diagram illustrating an example of dimensions of the mobile-terminal placing table according to the embodiment. FIG. 15 is a diagram illustrating a state in which the mobile terminal is placed on the mobile-terminal placing table according to the embodiment. FIG. 16 is a diagram illustrating an example of the mobile-terminal placing table according to the embodiment. FIG. 17 is a diagram illustrating another example of the mobile-terminal placing table according to the embodiment. FIG. 18 is a diagram illustrating another example of the mobile-terminal placing table according to the embodiment. FIG. 19 is a diagram illustrating another example of the mobile-terminal placing table according to the embodiment. FIG. 20 is a diagram illustrating another example of the mobile-terminal placing table according to the embodiment.

As illustrated in FIG. 13, the image capturing unit 41 of the mobile terminal 200 of the present embodiment is mounted at a position of a distance x from a left-side end portion of the mobile terminal 200, and at a position of a distance y from a lower-side end portion of the mobile terminal 200. As illustrated in FIG. 14, an L-shaped holder 20A that holds the mobile terminal 200 is installed on the front surface of the mobile-terminal placing table 20, based on the distance x (corresponding to a distance a in FIG. 14) and the distance y (corresponding to a distance b in FIG. 14), which indicate the mounted position of the image capturing unit 41 of the mobile terminal 200. That is, positional relationship between the mounter position (x, y) of the image capturing unit 41, and the installation position (a, b) of the holder 20A of the mobile-terminal placing table 20 satisfies relationship of “x=a, y=b”.

In FIG. 14, a dotted line L1 corresponds to a straight line facing the center of the turntable 10. In the present embodiment, the holder 20A of the mobile-terminal placing table 20 is designed such that the mounted position of the image capturing unit 41 is positioned on the dotted line L1 when the mobile terminal 200 is placed on an installation surface 20B in a state where the mobile terminal 200 abuts on the holder 20A. Further, the height of the installation surface 20B of the mobile-terminal placing table 20 is designed to be lower than a dotted line L2. This is because a lens of the image capturing unit 41 is not interrupted by the installation surface 20B in a state where the mobile terminal 200 is placed on the mobile-terminal placing table 20. When the mobile terminal 200 is placed on the installation surface 20B in a state where the mobile terminal 200 abuts on the holder 20A of the mobile-terminal placing table 20 designed as described above, the image capturing unit 41 of the mobile terminal 200 becomes in a state of being able to photograph the object to photo OBJ placed on the object-to-photo placing table 11, as illustrated in FIG. 15.

Note that, in the present embodiment, the mounted position of the image capturing unit 41 of the mobile terminal 200 lies in a position deviated from the center of the mobile terminal 200 to one side. Therefore, the mounted position of the image capturing unit 41 is positioned outwardly sticking out from the flat plate on the one side of the V-shaped structure with respect to the bent portion of the V shape of the relative-position changing unit 30, in a state where the mobile terminal 200 is placed on the mobile-terminal placing table 20, and thus the lens of the image capturing unit 41 is not interrupted by the flat plate. Further, as described above, the mounted position of the image capturing unit 41 is designed to be positioned on the dotted line L1, in a state where the mobile terminal 200 is placed on the mobile-terminal placing table 20. Therefore, an image can be captured in a state where the image capturing unit 41 and the object to photo OBJ placed on the object-to-photo placing table 11 face each other.

Various patterns can be considered for the size of the mobile terminal 200, and therefore, the mounted position of the image capturing unit 41 differs in each mobile terminal 200. Even in such a case, as illustrated in FIGS. 16 and 17, a plurality of types of mobile-terminal placing tables 20 designed for respective mounted positions (a, b), and (a′, b′) of the image capturing units 41 of the respective mobile terminals 200 are prepared, and the user exchanges the mobile-terminal placing table 20 designed for the mobile terminal 200 to be used, so that such a case can be supported. In addition, as illustrated in FIG. 18, an installation state of the mobile terminal 200 can be further stabilized, by extending the height of the installation surface 20B of the mobile-terminal placing table 20. In this case, an opening portion H for the image capturing unit designed for the mounted position (a, b) of the image capturing unit 41 of the mobile terminal 200 is provided in the installation surface 20B. Accordingly, the lens of the image capturing unit 41 is not interrupted by the installation surface 20B. Therefore, the image capturing unit 41 of the mobile terminal 200 becomes in a state being capable of photographing the object to photo OBJ placed on the object-to-photo placing table 11.

In addition, as illustrated in FIGS. 19 and 20, the mobile-terminal placing table 20 may be configured to be a U-shaped holder, by adding an additional holder 20C having a movable structure to the L-shaped holder 20A. In the example of FIG. 19, the additional holder 20C has a movable structure of being slidable in a direction of an arrow Y8 of either approaching an end portion of the installation surface 20B to abut thereon, or being away from the end portion. In the example of FIG. 20, an additional holder 20C′ has a movable structure of being rotatable around the hinge portion as a rotating shaft, in a direction of an arrow Y9 of either approaching the end portion of the installation surface 20B to abut thereon, or being away from the end portion. Note that force to hold the mobile terminal 200 placed on the mobile-terminal placing table 20 can be generated by using an elastic body such as a spring or rubber, or a structure to physically determine a position such as a claw or a latch. With the additional holder 20C, the installation state of the mobile terminal 200 can be further stabilized.

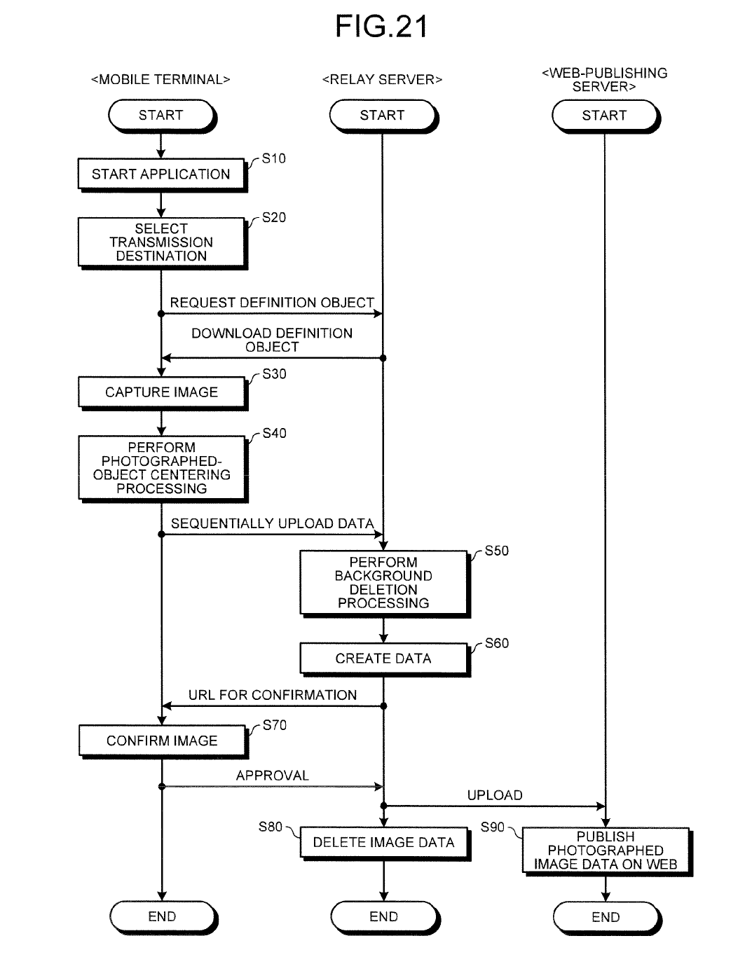

Processing of the image capturing system and the captured-image data publishing system according to the embodiment will be described with reference to FIG. 21. FIG. 21 is a flowchart illustrating an outline of the image capturing system and the captured-image data publishing system according to the embodiment.

As illustrated in FIG. 21, the terminal-equipment, controller of the mobile terminal 200 starts an application, in response to an application start command input by an operation of the user through the input/output unit 40 (step S10). In the present embodiment, the application started by the mobile terminal 200 is a program for executing various types of processing necessary for capturing an image or photographing, in a state where the object to photo OBJ on the turntable 10 of the image-capturing assist device 100 is rotated. Then, the user selects the web-publishing server 400, to which the cooperative service desired by the user is to be offered, as a transmission destination of the photographed image data, through a transmission destination selection screen displayed on the input/output unit 40 of the mobile terminal 200 (step S20). Following that, the second communication unit 43 of the mobile terminal 200 transmits, to the relay server 300, a command that requires the conditions (for example, the conditions that provide the number of images, the capacity, the image size, and the like) that provides the photographed image data uploadable to the transmission destination selected at step S20, as the definition object of the photographed image data. The control unit of the relay server 300 searches a database of definition objects stored in the storage unit of the relay server 300 in advance for the definition object. The communication unit of the relay server 300 transmits a search result to the mobile terminal 200. As described above, the mobile terminal 200 downloads the definition object of the photographed image data, which is going to be photographed and generated.

Then, the image capturing control unit 44 of the mobile terminal 200 controls the image capturing unit 41 according to the downloaded definition object to start the image capturing or photographing (step S30). At this time, the second communication unit 43 of the mobile terminal 200 transmits a control signal that rotates the turntable 10, to the image-capturing assist device 100. Accordingly, the image-capturing assist device 100 can rotate the object-to-photo placing table 11 on which the object to photo OBJ is placed, by controlling the actuator 13 by the drive control unit 14 of the turntable-equipment controller, at the same time as the start of the image capturing by the image capturing unit 41 of the mobile terminal 200. Further, the image processing unit 45 of the mobile terminal 200 executes image processing (photographed-object centering processing) of arranging the position of the object to photo OBJ placed on the object-to-photo placing table 11 to a center of image data (step S40). Details of the photographed-object centering processing will be described below. Following that, the second communication unit 43 of the mobile terminal 200 performs an upload, by sequentially transmitting the photographed image data photographed at step S30 and subjected to the image processing at step S40, to the relay server 300.

Then, the control unit of the relay server 300 executes the image processing (background deletion processing) of deleting the background portion other than the object to photo OBJ included in the photographed image data, with respect to the photographed image data uploaded from the mobile terminal 200 (step S50). Details of the background deletion processing will be described below. Then, the control unit of the relay server 300 stores the photographed image data subjected to the image processing at step S50, in the storage unit, as the photographed image data to be uploaded to the web-publishing server 400, and creates data for confirmation (a thumbnail image, and the like) of the user of the mobile terminal 200, corresponding to the photographed image data (step S60). Following that, the communication unit of the relay server 300 creates a preview page in the relay server 300 so that the user of the mobile terminal 200 can browse the data for confirmation, and transmits link information indicating a URL of the preview page (a URL for confirmation) to the mobile terminal 200.

Then, the terminal-equipment controller of the mobile terminal 200 displays a preview screen, through which the user can confirm the photographed image data to be uploaded to the web-publishing server 400, in the input/output unit 40, based on the link information received from the relay server 300. Then, the user confirms the photographed image data to be uploaded to the web-publishing server 400, through the preview screen displayed in the input/output unit 40 of the mobile terminal 200 (step S70). Following that, the user performs approval processing of the photographed image data to be uploaded to the web-publishing server 400, by selecting a selection item such as an approval button or a checkbox displayed at an arbitrary position on the preview screen. Then, the second communication unit 43 of the mobile terminal 200 transmits a signal that indicates confirmation and approval of the photographed image data to be uploaded to the web-publishing server 400 by the relay server 300, to the relay server 300. When having received the signal, the relay server 300 performs an upload, by transmitting the photographed image data for the upload to the web-publishing server 400 corresponding to the data for confirmation stored in the storage unit, to the web-publishing server 400. Then, the control unit of the relay server 300 deletes the preview page including the photographed image data for the upload to the web-publishing server 400, the data for confirmation corresponding to the photographed image data, and the like stored in the storage unit (step S80).

Then, the web-publishing server 400 publishes the photographed image data on the web, by executing various types of processing necessary for causing the photographed image data received from the relay server 300 to be browsable on the cooperation service (for example, the image publishing service of an EC site) offered by the web-publishing server 400 (step S90).

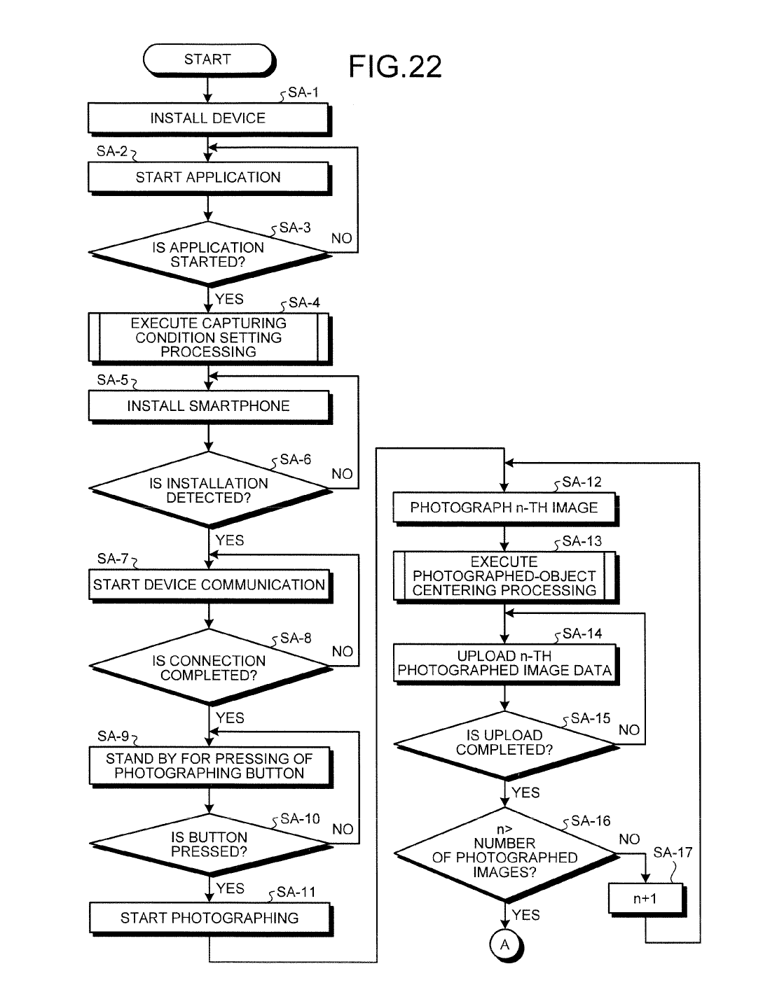

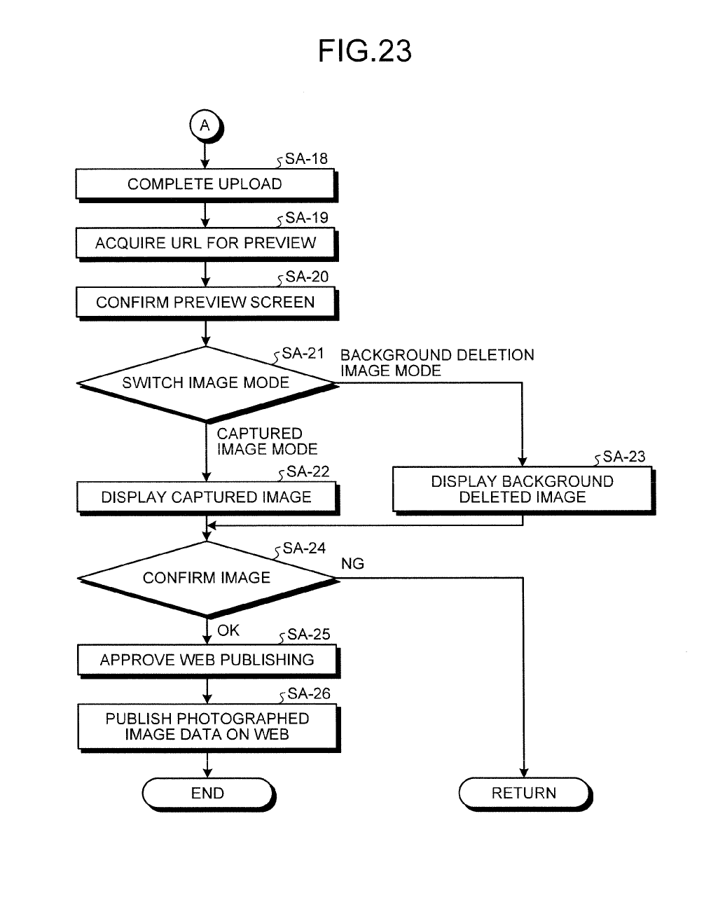

Details of processing of an image capturing system according to an embodiment will be described with reference to FIGS. 22 and 23. FIGS. 22 and 23 are flowcharts illustrating details of processing of an image capturing system according to an embodiment. Content of the processing illustrated in FIGS. 22 and 23 indicates details of the processing of the mobile terminal 200 and the like illustrated in FIG. 21.

As illustrated in FIG. 22, the user installs the image-capturing assist device 100, and places the object to photo OBJ on the turntable 10 (step SA-1). Then, the user performs an operation to start the application through the input/output unit 40 (step SA-2). Then, the terminal-equipment controller of the mobile terminal 200 determines whether starting the application, by determining presence of the application start command input through the input/output unit 40 by the operation of the user (step SA-3). At step SA-3, when there is no application start command, and the terminal-equipment controller determines not to start the application (No at step SA-3), the processing is returned to step SA-2. Meanwhile, at step SA-3, when there is the application start command, and the terminal-equipment controller determines to start the application (Yes at step SA-3), the terminal-equipment controller of the mobile terminal 200 starts the application, and the processing is moved on to a capturing condition setting flow, as the next processing (step SA-4).

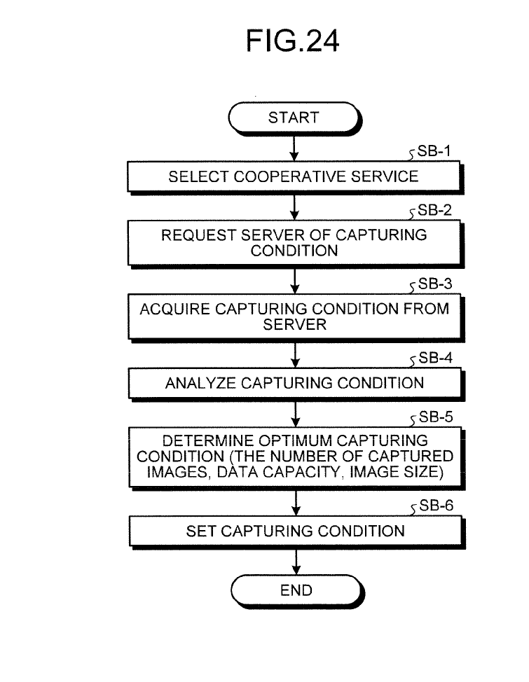

Here, details of the capturing condition setting processing executed at step SA-4 will be described with reference to FIG. 24. FIG. 24 is a flowchart illustrating details of the capturing condition setting processing according to the embodiment.

The image capturing system according to the present embodiment acquires an entire peripheral image of the object to photo OBJ. The uploadable number of captured images, data capacity, image size, and the like differ depending on the type of the cooperative service offered by the web-publishing server 400. Therefore, in the present embodiment, to avoid a state where images of the object to photo OBJ are photographed in numbers exceeding necessary number(s) or with capacity exceeding a necessary capacity, the capturing condition setting processing in which the mobile terminal 200 acquires the capturing conditions adapted to the cooperative service, through the relay server 300, in advance, is executed before starting the photographing. Accordingly, in the present embodiment, the number of captured images and the capacity are optimized, whereby a photographing time and an upload time can be shortened.

As illustrated in FIG. 24, the user selects the cooperative service, by selecting the web-publishing server 400 that offers the cooperative service desired by the user, as the transmission destination of the photographed image data, through the transmission destination selection screen displayed in the input/output unit 40 of the mobile terminal 200 (step SB-1). Then, the second communication unit 43 of the mobile terminal 200 transmits the command that requires the capturing conditions (for example, the conditions that define the number of images, the capacity, the image size, and the like) of the object to photo OBJ necessary for use of the cooperative service selected at step SB-1, to the relay server 300 (step SB-2). Then, the second communication unit 43 of the mobile terminal 200 acquires the capturing conditions of the object to photo OBJ necessary for use of the cooperative service, by receiving the capturing conditions corresponding to the cooperative service selected from the relay server 300 (step SB-3). The image capturing control unit 44 of the mobile terminal 200 then analyzes the capturing conditions acquired at step SB-3 (step SB-4). The image capturing control unit 44 of the mobile terminal 200 then determines whether the capturing conditions are optimum capturing conditions to capture an image by the image capturing unit 41 of the mobile terminal 200, from the analysis result based on the number of captured images, the data capacity, and the image size provided in the acquired capturing conditions, and the processing capacity of the mobile terminal 200 (step SB-5). Then, the image capturing control unit 44 of the mobile terminal 200 sets the capturing conditions of the object to photo OBJ after determining the acquired capturing conditions are the optimum capturing conditions (step SB-6). Then, the processing is moved on to step SA-5 of FIG. 22.

Referring back to FIG. 22, the user places the mobile terminal 200 on the mobile-terminal placing table 20 of the image-capturing assist device 100 (step SA-5). In the present embodiment, the mobile terminal 200 is a smartphone. That is, at step SA-5, the user performs an operation to install the smartphone in the image-capturing assist device 100. Then, the turntable-equipment controller of the image-capturing assist device 100 determines whether the mobile terminal 200 is installed on the mobile-terminal placing table 20, with a detection sensor (not illustrated) provided in the holder 20A or the installation surface 20B of the mobile-terminal placing table 20 of the image-capturing assist device 100 (step SA-6). At step SA-6, when the turntable-equipment controller of the image-capturing assist device 100 does not receive a detection signal from the detection sensor, and the installation of the smartphone is not detected (No at step SA-6), the processing is returned to step SA-5. Meanwhile, at step SA-6, when the turntable-equipment controller of the image-capturing assist device 100 receives the detection signal from the detection sensor, and the installation of the smartphone is detected (Yes at step SA-6), the processing is moved on to step SA-7.

Then, the first communication unit 17 of the image-capturing assist device 100 starts communication with the mobile terminal 200 (step SA-7). At step SA-7, the first communication unit 17 of the image-capturing assist device 100 attempts connection between the image-capturing assist device 100 and the mobile terminal 200, by executing pairing processing with the mobile terminal 200. The first communication unit 17 of the image-capturing assist device 100 then determines whether the connection with the mobile terminal 200 is completed (step SA-8). At step SA-8, when the first communication unit 17 of the image-capturing assist device 100 determines that the connection with the mobile terminal 200 is not completed, such as failure of the pairing processing (No at step SA-8), the processing is returned to step SA-7. Meanwhile, at step SA-8, when the first communication unit 17 of the image-capturing assist device 100 succeeds in the pairing processing and determines that the connection with the mobile terminal 200 is completed (Yes at step SA-8), the processing is moved on to step SA-9.

Then, the image capturing control unit 44 of the mobile terminal 200 is moved on to a standby state to detect a detection signal which is generated when the photographing button displayed at an arbitrary position on the image capturing control screen displayed in the input/output unit 40 is pressed by the operation of the user (step SA-9). When the photographing button is not pressed (No at step SA-10), the image capturing control unit 44 of the mobile terminal 200 then allows the processing to return to step SA-9. When the photographing button is pressed (Yes at step SA-10), the processing is moved on to step SA-11. The image capturing control unit 44 of the mobile terminal 200 then generates the control signal according to the capturing conditions set at step SA-4, and starts the photographing of the object to photo OBJ on the turntable 10 of the image-capturing assist device 100, by transmitting the control signal to the image-capturing assist device 100 by the second communication unit 43 (step SA-11). As described above, the terminal-equipment controller of the mobile terminal 200 according to the present embodiment controls the actuator 13 through the turntable-equipment controller, at the time to start the image capturing by the image capturing unit 41, and continuously or intermittently photographs the object to photo OBJ placed on the object-to-photo placing table 11, in a sequential manner, in a state of rotating the object-to-photo placing table 11 around the rotating shaft.

To be specific, the image capturing control unit 44 of the mobile terminal 200 controls the image capturing unit 41 according to the capturing conditions to photograph an n-th image, and generates the photographed image data (step SA-12). Then, the image processing unit 45 of the mobile terminal 200 executes the photographed-object centering processing with respect to the generated photographed image data (step SA-13). In the present embodiment, the photographed-object centering processing executed at step SA-13 is processing executed based on a plurality of the photographed image data, and thus the processing is skipped at the point of time when only the n-th photographed image data is generated. Following that, when and after the (n+1)-th photographed image data is generated, the photographed-object centering processing is executed, based on the photographed image data of the previous frame and the current frame such as the n-th frame and the (n+1)-th frame. Details of the photographed-object centering processing will be described below.

Then, the second communication unit 43 of the mobile terminal 200 performs an upload of the n-th photographed image data to the relay server 300, by transmitting the n-th photographed image data subjected to the photographed-object centering processing at step SA-13, to the relay server 300 (step SA-14). Following that, at step SA-15, when the signal of transmission completion is not acquired from the relay server 300 through the second communication unit 43 and it is determined that the upload is not completed (No at step SA-15), the processing is returned to step SA-14. Meanwhile, at step SA-15, when the signal of transmission completion is acquired from the relay server 300 through the second communication unit 43, and it is determined that the upload is completed (Yes at step SA-15), the image capturing control unit 44 of the mobile terminal 200 determines whether a counter value (n in this case) that indicates the number of the photographed image data, the upload of which is completed at step SA-15, is larger than the number of captured images provided in the capturing conditions (step SA-16).

At step SA-16, when the counter value is determined to be the number of captured images provided in the capturing conditions or less (n the number of captured images) (No at step SA-16), the image capturing control unit 44 increments the counter value by 1 (step SA-17), and allows the processing to return to step SA-12. Following that, the image capturing control unit 44 repeats the processing of steps SA-12 to SA-17, until the counter value is determined to be larger than the number of captured images provided in the capturing conditions at step SA-16 (n>the number of captured images). Then, when the counter value is determined to be larger than the number of captured images provided in the capturing conditions at step SA-16 (n>the number of captured images) (Yes at step SA-16), the processing is moved on to step SA-18 illustrated in FIG. 23.

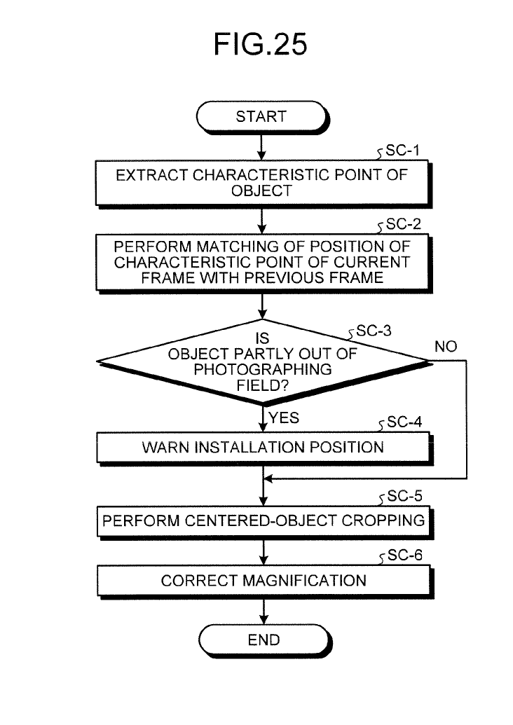

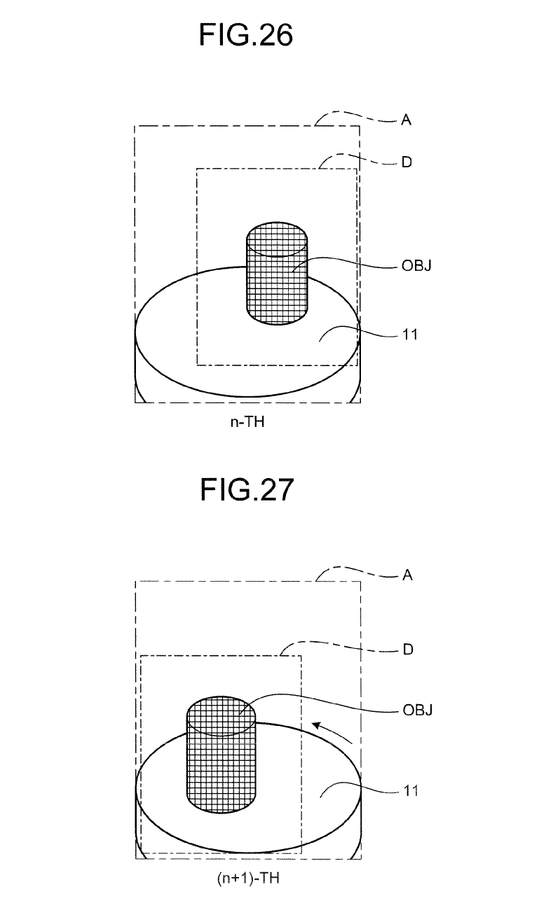

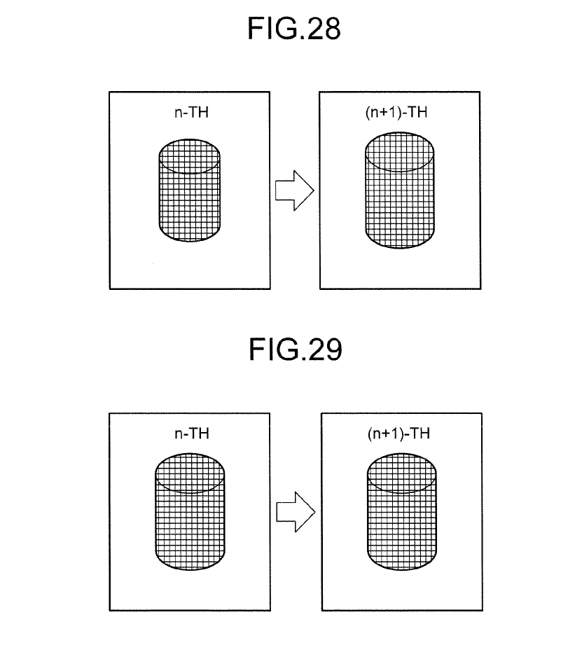

Here, details of the photographed-object centering processing executed at step SA-13 of FIG. 22 will be described with reference to FIGS. 25 to 29. FIG. 25 is a flowchart illustrating details of the photographed-object centering processing according to the embodiment. FIG. 26 is a diagram illustrating a state of the object to photo rotated on the object-to-photo placing table according to the embodiment, and of the object to photo, which is captured as the n-th photographed image data. FIG. 27 is a diagram illustrating a state of the object to photo rotated on the object-to-photo placing table according to the embodiment, and of the object to photo, is captured as the (n+1)-th photographed image data. FIG. 28 is a diagram for describing centered-object cropping processing included in the photographed-object centering processing according to the embodiment. FIG. 29 is a diagram for describing magnification correction processing included in the photographed-object centering processing according to the embodiment.

The image capturing system of the present embodiment captures a moving image or a plurality of still images by the image capturing unit 41, while rotating the object to photo OBJ as an object placed on the object-to-photo placing table 11. At that time, if the object to photo OBJ is placed on a position deviated from the rotation center of the object-to-photo placing table 11, failure that the position of the object to photo OBJ that falls within the photographing field A (see FIGS. 26 and 27) changes, the magnification of the object to photo OBJ changes, and the position does not fall within the photographing field A and the object to photo OBJ is partly out of the photographing field A, may occur.

The failure will be described with reference to FIGS. 26 and 27. The example of FIG. 26 illustrates a state (n-th state) of the object to photo OBJ on the object-to-photo placing table 11 rotated from the time when the capturing is started at step SA-11 of FIG. 22, and of the object to photo OBJ, which is captured as the n-th photographed image data. The example of FIG. 27 illustrates a state ((n+1)-th state) of the object to photo OBJ, which is captured as the (n+1)-th photographed image data, after the object-to-photo placing table 11 is further rotated from the n-th state illustrated in FIG. 26. FIGS. 26 and 27 illustrate the photographed image data captured in the photographing field A. In the present embodiment, in the photographed image data captured in the photographing field A, a part of the photographed image data included in an image storing range D, which is set according to the image size provided in the capturing conditions, can be the photographed image data for the upload to the web-publishing server 400. As compared with FIGS. 26 and 27, the object to photo OBJ is placed on the position deviated from the rotation center of the object-to-photo placing table 11, and thus between the n-th state and the (n+1)-th state, the position of the object to photo OBJ changes. With the change, between the n-th state and the (n+1)-th state, the magnification of the object to photo OBJ also changes.

Therefore, in the present embodiment, to eliminate the above-described failure, the photographed-object centering processing described in FIG. 25 is executed. Here, the photographed-object centering processing is processing of forming the photographed image data in a state where the object to photo OBJ is arranged on the rotation center, by making the position and the size of the object to photo OBJ uniform by the image processing performed in parallel with photographing the object to photo OBJ.

As illustrated in FIG. 25, the image processing unit 45 of the mobile terminal 200 extracts a characteristic point of the object to photo OBJ as the object (step SC-1). At step SC-1, the image processing unit 45 of the mobile terminal 200 extracts the characteristic point of the object to photo OBJ, by applying various characteristic-point extraction methods typically used in the image processing field to the photographed image data including the object to photo OBJ. Then, the image processing unit 45 of the mobile terminal 200 performs matching of a position of the photographed image data of the previous frame (for example, n-th frame) to a position of the characteristic point of the photographed image data of the current frame (for example, (n+1)-th frame) (step SC-2). Then, the image processing unit 45 of the mobile terminal 200 determines whether the object is in a state of being partly cut of a photographing field, by determining whether the whole of the object to photo OBJ as the object is in a state of falling within the image storing range D (step SC-3).

At step SC-3, when the image processing unit 45 of the mobile terminal 200 determines that only a part of the object to photo OBJ falls within the image storing range D, and the object to photo OBJ as a whole is not in a state of falling within the image storing range D, that is, when the object is in a state of being partly out of the photographing field (Yes at step SC-3), the processing is moved on to step SC-4. Then, the image processing unit 45 of the mobile terminal 200 warns the user of the installation position, by displaying a warning screen that prompts the user to modify the installation position of the object to photo OBJ, in the input/output unit 40 (step SC-4). Following that, the processing is moved on to step SC-5.

Meanwhile, at step SC-3, when the image processing unit 45 of the mobile terminal 200 determines that the whole of the object to photo OBJ is in a state of falling within the image storing range D, that is, when the object is not in a state of being partly out of the photographing field (No at step SC-3), the image processing unit 45 crops a part of the photographed image data included in the image storing range D, of the photographed image data photographed in the photographing field A to execute a cropping processing to center the object to photo OBJ, hereinafter centered-object cropping processing (step SC-5). The example of FIG. 28 illustrates an image (the left-side image in FIG. 28) that is a part of the image data in the image storing range D cropped from the photographed image data in the n-th state illustrated in FIG. 26, and an image (the right-side image in FIG. 28) that is a part of the image data in the image storing range D cropped from the photographed image data in the (n+1)-th state illustrated in FIG. 27. When comparing these images, it is found that the magnification of the object to photo OBJ differs between the n-th state and the (n+1)-th state. This derives from photographing the object to photo OBJ placed on the position deviated from the rotation center of the object-to-photo placing table 11.

Then, the image processing unit 45 of the mobile terminal 200 executes magnification correction processing of changing a magnification of one of these images to accord with the magnification of the other of these images, for the photographed image data subjected to the centered-object cropping processing at step SC-5 (step SC-6). In the example of FIG. 29, the image processing unit 45 executes the magnification correction processing, by changing the magnification of the n-th photographed image data subjected to the centered-object cropping processing illustrated in FIG. 28 in accordance with the magnification of the (n+1)-th photographed image data subjected to the centered-object cropping processing illustrated in FIG. 28. Here, in the magnification correction processing of the present embodiment, processing of changing a smaller magnification of the photographed image data in accordance with a larger magnification, within a range where the dots in the photographed image data are not disordered when the magnification is changed and enlarged. Note that, in FIG. 29, an example of changing the smaller magnification of the photographed image data in accordance with the larger magnification to enlarge the photographed image data has been described. However, the embodiment is not limited to the example. In the magnification correction processing of the present embodiment, processing of changing the larger magnification of the photographed image data in accordance with the smaller magnification to reduce the photographed image data may be performed. Following that, the processing is moved on to step SA-18 of FIG. 23.

As illustrated in FIG. 23, when the upload of the photographed image data corresponding to the number of captured images provided in the capturing conditions to the relay server 300 is completed (step SA-18), the second communication unit 43 of the mobile terminal 200 acquires the link information that indicates the URL (URL for confirmation) of the preview page for confirming the photographed image data to be uploaded to the web-publishing server 400, from the relay server 300 (step SA-19). Then, the terminal-equipment controller of the mobile terminal 200 displays the preview screen, through which the user can confirm the photographed image data for an upload to the web-publishing server 400, in the input/output unit 40, based on the link information received from the relay server 300. Then, the user confirms the photographed image data to be uploaded to the web-publishing server 400, through the preview screen displayed in the input/output unit 40 of the mobile terminal 200 (step SA-20).

Then, the user performs switching processing of an image mode, by selecting either a photographed image mode or a background deletion image mode, by selecting a selection item such as an image mode switching button or a checkbox displayed at an arbitrary position on the preview screen displayed in the input/output unit 40 of the mobile terminal 200 (step SA-21). The photographed image mode is to actually display the photographed image data, instead of the data for confirmation. The background deletion image mode is to perform image processing of deleting the background other than the object to photo OBJ in the photographed image data.

At step SA-21, when the photographed image mode is selected (step SA-21: photographed image mode), the terminal-equipment controller of the mobile terminal 200 acquires the corresponding photographed image data stored in the storage unit of the relay server 300 through the second communication unit 43, and displays the photographed image data in the input/output unit 40 (step SA-22). Then, the processing is moved on to step SA-24.

Meanwhile, at step SA-21, when the background deletion image mode is selected (step SA-21: background deletion image mode), the terminal-equipment controller of the mobile terminal 200 acquires the photographed image data subjected to the background deletion processing executed by the control unit of the relay server 300, through the second communication unit 43, and displays the photographed image data in the input/output unit 40 (step SA-23). Following that, the processing is moved on to step SA-24. Details of the background deletion processing will be described below. In the present embodiment, the background deletion processing is executed when the background deletion image mode is selected after the upload of the photographed image data to the relay server 300. Therefore, the user can select whether executing the background deletion processing after confirming the photographed image data.

Then, the user confirms the image, according to whether selecting the selection item such as a checkbox that indicates completion of confirmation, with respect to the Photographed image data corresponding to the respective image modes displayed in the input/output unit 40 of the mobile terminal 200 (step SA-24).

At step SA-24, when the checkbox that indicates the completion of confirmation is not selected, and the image confirmation result by the user is NG (no-good) (NG at step SA-24), the terminal-equipment controller of the mobile terminal 200 causes the processing illustrated in FIGS. 22 and 23 to return, and performs the present processing again.

Meanwhile, at step SA-24, when the checkbox that indicates the completion of confirmation is selected, and the image confirmation result of the user is OK (OK at step SA-24), the second communication unit 43 of the mobile terminal 200 performs approval of publication on the web, by transmitting the signal that indicates confirmation and approval of the photographed image data to be uploaded to the web-publishing server 400 by the relay server 300, to the relay server 300 (step SA-25). Then, the photographed image data approved by the user is published on the web, by being uploaded to the web-publishing server 400 through the relay server 300 (step SA-26).

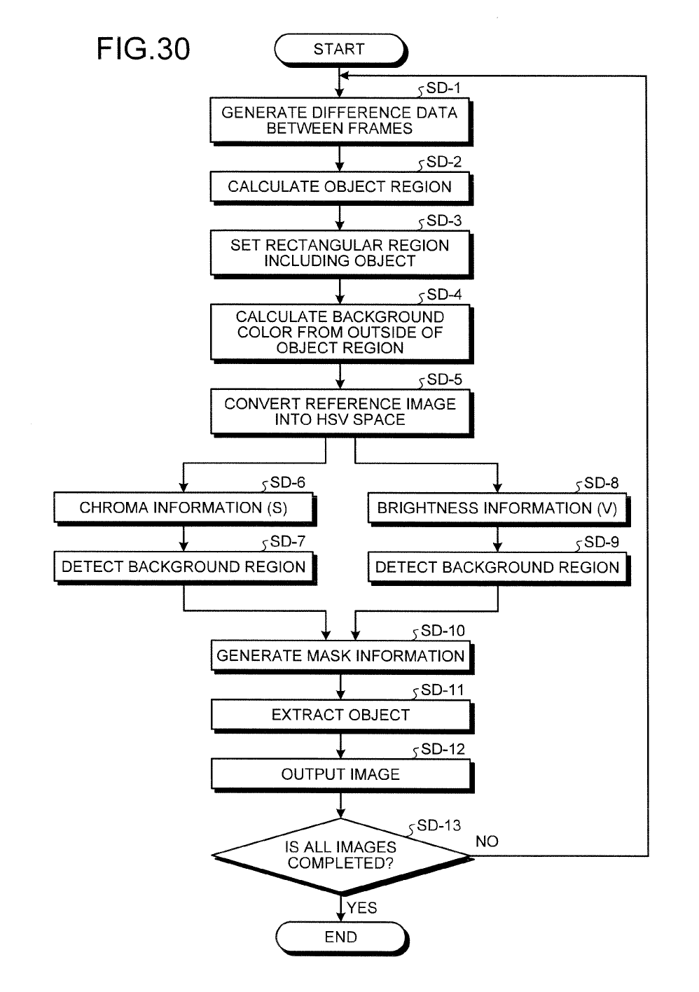

Here, details of the background deletion processing executed by the control unit of the relay server 300, in response to the control signal transmitted from the mobile terminal 200, when the background deletion image mode is selected at step SA-21 of FIG. 23, will be described with reference to FIG. 30. FIG. 30 is a flowchart illustrating details of the background deletion processing according to the embodiment.

As illustrated in FIG. 30, the control unit of the relay server 300 creates difference data between a plurality of frames (for example, the n-th photographed image data and the (n+1)-th photographed image data) (step SD-1). Then, the control unit of the relay server 300 calculates an object region (that is, a region occupied by the object to photo OBJ in the photographed image data) based on the difference data created at step SD-1 (step SD-2). Then, the control unit of the relay server 300 sets a rectangular region including the object to photo OBJ as the object (that is, a region corresponding to the image storing range D) in the photographed image data (step SD-3). Then, the control unit of the relay server 300 calculates a background color from an outside of the object region in the rectangular region (step SD-4).

Then, the control unit of the relay server 300 converts a reference image into an HSV space (step SD-5), and performs processing of extracting chroma information (S) to detect a background region (steps SD-6 and SD-7), and processing of extracting brightness information (V) to detect the background region (steps SD-8 and SD-9), in parallel, and then generates mask information (step SD-10). Then, the control unit of the relay server 300 extracts the object to photo OBJ as the object, based on the mask information (step SD-11), and generates an output image subjected to the background deletion processing, as image processing of deleting the background other than the object to photo OBJ in the photographed image data (step SD-12).

Then, the control unit of the relay server 300 determines whether the processing of steps SD-1 to SD-12 has been executed with respect to all of photographed image data that are targets of the background deletion processing (step SD-13). At step SD-13, when the control unit of the relay server 300 determines that above processing has not been executed with respect to the all of photographed image data (No at step SD-13), the processing is returned to step SD-1, and the control unit performs similar processing between next frames. Meanwhile, at step SD-13, when the control unit of the relay server 300 determines that the processing has been executed with respect to the all of photographed image data (Yes at step SD-13), the control unit transmits the output image to the mobile terminal 200 through the communication unit so that the background deleted image is displayed at step SA-23 of FIG. 23.

As described above, according to the image capturing system and the captured-image data publishing system of the present embodiment, efficiency of photographing, when an image of the object to photo on the turntable 10 is photographed from various directions, can be improved.

Here, conventionally, a plurality of images of an external appearance of an object is photographed from multiple viewpoints, and the plurality of images is intermittently switched and displayed, in order to transmit as much information as possible to a viewer at the time of uploading to the web. At that time, there are the following problems. The first problem is that, in a case where an expensive hardware configuration is required, trial use or individual-level introduction is difficult, and the configuration of an image capturing unit, a captured image holder, a control unit, edit software, and the like is complicated, and thus a certain level of specialized knowledge is required, and the configuration cannot be easily used. The second problem is that, although there is an easy-to-use smartphone application, the application corresponds to photographing only, and is not an application that supports interaction with the turntable and automatic web upload, and thus the operation is complicated. The third problem is that preparation of data in accordance with each upload site is required when performing an upload to the web, and a lot of labor is required when performing an upload to a plurality of sites.

Meanwhile, according to the captured-image data publishing system of the present embodiment, the above problems are solved, and processing from the preparation for photographing, to actual performance of photographing, editing, and an upload to the web can be realized with an inexpensive configuration. Further, a series of operation is simplified, and even a person who does not have specialized knowledge can easily perform an upload to an EC site or to the web for the purpose of publication of own work. As described above, according to the present embodiment, a system that enables easy and simple operations from photographing to an upload to the web can be offered.

Note that in the above-embodiment, an example of performing the photographed-object centering processing as the image processing at the mobile terminal 200, and executing the background deletion processing as the image processing at the relay server 300 has been described. However, the embodiment is not limited thereto. In the present embodiment, the system may be configured to execute these pieces of image processing in either one of the mobile terminal 200 or the relay server 300.

According to an image capturing system and a captured-image data publishing system, an effect to improve the efficiency when photographing an object to photo on a turntable from various directions is exhibited.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image capturing system to capture an image of an object to be photographed from various directions, the system comprising:
a mobile terminal including:
an image capturing unit, and
a terminal-equipment controller configured to control the mobile terminal; and
an image-capturing assist device including:
a turntable including:
an object-to-photo placing table on which the object to be photographed is placed,
a housing rotatably supporting the object-to-photo placing table around a rotating shaft,
an actuator configured to rotate the object-to-photo placing table around the rotating shaft, and a turntable-equipment controller configured to control the turntable, and
a mobile-terminal placing cable held to face the housing, and configured to place the mobile terminal in a state where the image capturing unit and the object to be photographed placed on the object-to-photo placing table face each other,
wherein the mobile terminal and the image-capturing assist device perform communication therebetween, and
the terminal-equipment controller controls the actuator through the turntable-equipment controller, at a time when starting image capturing by the image capturing unit, and intermittently or continuously captures an image of the object to be photographed placed on the object-to-photo placing table, in a sequential manner, in a state of rotating the object-to-photo placing table around the rotating shaft.

2. The image capturing system according to claim 1, wherein the image-capturing assist device further includes a relative-position changing unit to hold the mobile-terminal placing table with respect to the housing, and to change a relative position of the mobile-terminal placing table with respect to the object-to-photo placing table.

3. The image capturing system according to claim 2, wherein the relative-position changing unit changes the relative position, by being slid in a horizontal direction with respect to the object-to-photo placing table, and/or sliding the mobile-terminal placing table in an vertical direction.

4. The image capturing system according to claim 1, wherein the turntable further includes a background unit configured to protrude upward from the object-to-photo placing table, to surround a part of the object-to-photo placing table, and to be positioned in an image capturing region of the image capturing unit, in a state where the mobile terminal is placed on the mobile-terminal placing table.

5. The image capturing system according to claim 4, wherein the background unit is configured to switch an expanded state of surrounding a part of the object-to-photo placing table, and an accommodated state of being accommodated in a periphery of the object-to-photo placing table.

6. The image capturing system according to claim 1, wherein the turntable further includes light source units configured to irradiate the object to be photographed placed on the object-to-photo placing table with light.

7. A captured-image data publishing system comprising:
an image capturing system according to claim 1; and
a relay server configured to perform communication with the mobile terminal, and to automatically upload capture image data generated by photographing the object to be photographed, to a predetermined web-publishing server,
wherein the relay server and/or the terminal-equipment controller processes the photographed image data generated by photographing the object to be photographed, according to a condition required by the web-publishing server.
